(19) United States
(12) Patent Application Publication
(10) Pub. No.: US 2008/0226532 A1
(43) Pub. Date: Sep. 18, 2008

(54) LIGHT METAL BASED MATERIAL SYSTEM FOR HYDROGEN STORAGE

(76) Inventors: Zhigang Zak-Fang, Salt Lake City, UT (US); Jun Lu, Salt Lake City, UT (US); Hong Yong Sohn, Salt Lake City, UT (US)

Correspondence Address: THORPE NORTH & WESTERN, LLP., P.O. Box 1219, SANDY, UT, 84091-1219, US

(21) Appl. No.: 11/925,380

(22) Filed: Oct. 26, 2007

Related U.S. Application Data
(60) Provisional application No. 60/854,992, filed on Oct. 27, 2006.

(51) Int. Cl. C01B 21/00; C01B 3/00

(52) U.S. Cl. 423/351; 423/658.2

(57) ABSTRACT

The invention provides methods, compositions, and systems for a reversible hydrogen storage material. The hydrogen storage material contains a lithium-magnesium compound, having LiMgN in a dehydrogenated state and a hydrogenated lithium magnesium product in a hydrogenated state, where the hydrogenated and dehydrogenated states are reversible. The lithium-magnesium compound is formed by reacting MgH₂ and LiNH₂ in a substantially inert atmosphere in amounts sufficient to obtain a hydrogen adsorption of at least 3 wt %, and in many cases up to about 8.1 wt %.

### RELATED APPLICATIONS

This application claims the benefit of U.S. Provisional Patent Application No. 60/854,992, filed Oct. 27, 2006 which is incorporated herein by reference.

### STATEMENT OF GOVERNMENT RIGHTS

This invention was made with government support under Grant No. DE-FC36-05GO15069 awarded by U.S. Department of Energy. The government has certain rights to this invention.

### FIELD OF THE INVENTION

The present invention relates generally to hydrogen storage materials. More particularly, the present invention relates to methods of making reversible hydrogen storage materials, methods of reversibly storing hydrogen, systems of reversibly storing hydrogen, and compositions of hydrogen storage materials. As such, the present invention relates to the fields of chemistry, metallurgy, and materials science.

### BACKGROUND OF THE INVENTION

Hydrogen is a promising alternate energy fuel source. Hydrogen offers clean emissions and can be used as a fuel for fuel cells or burned directly in an internal combustion engine similar to standard gasoline engines. Additionally, hydrogen supplies three times the energy per pound of gasoline. However, hydrogen is also much less dense than gasoline creating problems with storage. The difference in density means that hydrogen fuel tanks must be large. Demonstrations of hydrogen powered vehicles have typically used compressed hydrogen gas, but even in this form hydrogen is still much less dense than gasoline. Because of the low density, even compressed hydrogen will not give a car as useful a travel range as gasoline. However, advances in hydrogen storage technology have achieved increased hydrogen densities through incorporation in metal hydrides. Nevertheless, the present metal hydride hydrogen storage systems have heavy metal compositions and low hydrogen contents making them inefficient and impracticable in many applications.

In recent years, a great deal of research and development efforts on solid hydrogen storage materials has included inorganic solid metal hydride materials. Typically these materials are complex metal hydrides of light metals of three categories: alanates, borohydrides, and amides. The primary advantage of using these complex metal hydrides versus simple metal hydrides is that, generally, they contain higher hydrogen contents.

However, for hydrogen storage materials in practical civilian applications, there are also a number of other critical requirements for dehydrogenation and hydrogenation reactions, including maintaining high kinetic rates, low temperature, and low pressure. The properties and performance of the complex metal hydrides often fall short in meeting one or more aspects of these critical requirements. For example, the rates of some reactions are very slow and the temperatures of these reactions are frequently unacceptably high. Needless to say, it is highly desirable if all hydrogen contained in the system can be released at low temperatures. At the present time, development of solid hydrogen storage materials, by either improving existing materials or discovering new materials that meet all requirements for practical applications, remains a complex and challenging task.

### SUMMARY OF THE INVENTION

It has been recognized that it would be advantageous to develop a light metal based material for hydrogen storage.

The invention provides a reversible hydrogen storage system comprising a vessel containing a hydrogen storage material. The hydrogen storage material contains a lithium-magnesium compound, having LiMgN in a hydrogen desorbed state and a hydrogenated lithium-magnesium product in a hydrogenated state, where the hydrogenated and desorbed states are reversible.

Additionally, the invention provides compositions and methods relating to reversible hydrogen storage materials. In one embodiment, a reversible hydrogen storage material composition comprises a lithium-magnesium compound, having a LiMgN in a hydrogen desorbed state. The lithium-magnesium compound can be formed by reacting MgH₂ and LiNH₂ in a substantially inert atmosphere in amounts sufficient to obtain a reversible hydrogen adsorption of at least about 3 wt %. The lithium-magnesium compound also has a hydrogenated lithium-magnesium product in a hydrogenated state. The hydrogenated and desorbed states are reversible.

In another embodiment, a method of reversibly storing hydrogen comprises the steps of hydrogenating LiMgN to form a hydrogenated lithium-magnesium product and desorbing hydrogen from the hydrogenated lithium-magnesium product to regenerate LiMgN.

In yet another embodiment, the invention provides a method of making a reversible hydrogen storage material by heating MgH₂ and LiNH₂ in a substantially inert atmosphere forming a lithium-magnesium compound that has a hydrogen content of at least about 3 wt %. The lithium-magnesium compound desorbs hydrogen to form LiMgN and reacts with hydrogen to form a hydrogenated lithium-magnesium product.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1(A) is a thermogravimetric analysis (TGA) profile of MgH₂/LiNH₂ mixture after 24-hour jar-roll milling in accordance with an embodiment of the present invention.

FIG. 1(B) is a TGA profile of MgH₂/LiNH₂ mixture after high energy milling for 2 hours under 70 bar of pressurized hydrogen in accordance with an embodiment of the present invention.

FIG. 1(C) is a differential thermal analysis (DTA) profile of MgH₂/LiNH₂ mixture after 24-hour jar-roll milling in accordance with an embodiment of the present invention.

FIG. 1(D) is a DTA profile of MgH₂/LiNH₂ mixture after high energy milling for 2 hours under 70 bar of pressurized hydrogen in accordance with an embodiment of the present invention.

FIG. 2 illustrates X-ray diffraction (XRD) patterns of A) MgH₂/LiNH₂ mixture before milling, B) MgH₂/LiNH₂ mixture after milling, and C) after complete dehydrogenation, in accordance with an embodiment of the present invention.

FIG. 3 is a TGA profile of LiMgN after hydrogenation at 280° C. under 2000 psi hydrogen pressure, Curve A shows the hydrogen generation under atmospheric argon and heating rate of 5° C./min, Curve B shows the temperature profile, in accordance with an embodiment of the present invention.

FIG. 4 illustrates XRD patterns of A) LiMgN and B) LiMgN after rehydrogenation, in accordance with an embodiment of the present invention.

FIG. 5 is a TGA profile of TiCl₃-doped LiMgN after hydrogenation at 160° C. under 2000 psi hydrogen pressure for 6 hours, Curve A shows the hydrogen release under argon and heating rate of 5° C./min, Curve B shows the temperature profile, in accordance with an embodiment of the present invention.

FIG. 6 is a TGA profile of TiCl₃-doped LiMgN after 5 hydrogenation/dehydrogenation cycles after hydrogenation at 160° C. under 2000 psi hydrogen pressure for 6 hours, Curve A shows the hydrogen release under argon and heating rate of 5° C./min, Curve B shows the temperature profile, in accordance with an embodiment of the present invention.

FIG. 7 illustrates XRD patterns of A) TiCl₃-doped LiMgN, B) TiCl₃-doped LiMgN after rehydrogenation, and C) dehydrogenation products of hydrogenated Ti Cl₃-doped LiMgN, in accordance with an embodiment of the present invention.

FIG. 8 illustrates FTIR absorption spectra for three samples, A) ball milled TiCl₃-doped LiNH₂/MgH₂ mixture, B) after dehydrogenation and C) after rehydrogenation of the dehydrogenated product, in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

It must be noted that, as used in this specification and the appended claims, the singular forms “a,” “an,” and “the” include plural referents unless the context clearly dictates otherwise. Thus, for example, reference to “a lithium-magnesium compound” includes one or more of such materials, reference to “an additive” includes reference to one or more of such additives, and reference to “a heating step” includes reference to one or more of such steps.

### DEFINITIONS

In describing and claiming the present invention, the following terminology will be used in accordance with the definitions set forth below.

As used herein, “inherent hydrogen storage capacity” or “hydrogen storage capacity” refers to the total weight percentage of a material that is hydrogen. This total weight includes hydrogen stored chemically as a hydrogen-containing compound and is not intended to include free hydrogen gas which may be trapped or absorbed within the material.

As used herein, “react” or “reacting” refers to any interaction between the identified materials which results in an association of the identified materials. A reaction of materials can result in formation and/or destruction of chemical bonds, ionic association, or the like.

As used herein, “thermogravimetric analysis” or “TGA” is a technique for measurement of dehydrogenation properties.

As used herein, “X-ray diffraction analysis” or “XRD” is a technique in crystallography in which the pattern of X-rays diffracted through the closely spaced lattice of atoms in a crystal is recorded and then analyzed, potentially revealing the molecular structure of that lattice.

As used herein, “lithium-magnesium compound” refers to a reversible hydrogen storage material produced by the addition of LiNH₂ to MgH₂ in amounts that provide a hydrogen storage capacity of at least about 3%. This term includes the hydrogen storage material in both hydrogenated and dehydrogenated states or a mixture of such states.

As used herein, “hydrogenated lithium-magnesium product” refers to a lithium, magnesium, hydrogen-containing product resulting from adsorbtion of hydrogen by the lithium magnesium nitride (LiMgN). The hydrogenated lithium-magnesium product can include at least one of lithium hydrides, magnesium hydrides, magnesium amides, lithium, amides, magnesium amides, lithium imides, magnesium imides, combinations of these compounds, and mixtures of these amide and imide compounds having varying ratios of magnesium, lithium, nitrogen, and hydrogen, although other compounds may also be formed which have yet to be identified. However, the hydrogenated lithium-magnesium product can often be a complex mixture of the above listed hydrides, amides, and imides.

As used herein, “adsorb,” “adsorbing,” “adsorbed,” and “adsorbtion” refers to the process by which a material is hydrogenated, adsorbed, or absorbed, and is synonymous with, or interchangeably used with, these terms. This term is meant to include all means and/or mechanisms by which hydrogen may be bonded, adsorbed, absorbed, hydrogenated, hydrided, or reacted with a material.

As used herein, “adsorb,” “adsorbing,” “adsorbed,” and “adsorbtion” refers to the process by which a material is hydrogenated, adsorbed, or absorbed, and is synonymous with, or interchangeably used with, these terms. This term is meant to include all means and/or mechanisms by which hydrogen may be bonded, adsorbed, absorbed, hydrogenated, hydrided, or reacted with a material.

As used herein, “desorb,” “desorbing,” desorbed,” and desorption” refers to the process by which a material is dehydrogenated or desorbed, and is synonymous with, or interchangeably used with, these terms. This term is meant to include all means and/or mechanisms by which hydrogen may be cleaved, reacted, dehydrided, dehydrogenated, or desorbed from a material.

As used herein, “substantially” or “substantial” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking, the nearness of completion will be so as to have the same overall result as if absolute and total completion were obtained. The use of “substantially” is equally applicable when used in a negative connotation to refer to the complete or near complete lack of action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still contain such an item as long as there is no measurable effect thereof.

As used herein, “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 10 to about 50” should be interpreted to include not only the explicitly recited values of about 10 to about 50, but also include individual values and sub-ranges within the indicated range. Thus, included in this numerical range are individual values such as 20, 30, and 40 and sub-ranges such as from 10-30, from 20-40, and from 30-50, etc. This same principle applies to ranges reciting only one numerical value. Furthermore, such an interpretation should apply regardless of the breadth of the range or the characteristics being described.

### INVENTION

The present invention provides methods and compositions for a ternary light metal nitride, specifically LiMgN, as a hydrogen storage material. In one embodiment, a reversible hydrogen storage system can comprise a vessel containing a hydrogen storage material that includes a lithium-magnesium compound. The lithium-magnesium compound can have a LiMgN in a hydrogen desorbed state and a hydrogenated lithium-magnesium product in a hydrogen adsorbed state, such that the hydrogen adsorbed and desorbed states are reversible.

Additionally, a method of making a reversible hydrogen storage material can comprise the step of heating MgH₂ and LiNH₂ in a substantially inert atmosphere forming a lithium-magnesium compound that has a hydrogen adsorption of at least about 3 wt %. The lithium-magnesium compound can desorb hydrogen to form a LiMgN and adsorb hydrogen to form a hydrogenated lithium-magnesium product. In one embodiment, a method of reversibly storing hydrogen can comprise the steps of adsorbing hydrogen with a LiMgN to form a hydrogenated lithium-magnesium product and desorbing hydrogen from the hydrogenated lithium-magnesium product to form the LiMgN.

Generally, a reversible hydrogen storage material can comprise a lithium-magnesium compound. The lithium-magnesium compound can have a LiMgN in a hydrogen desorbed state and can be formed by reacting MgH₂ and LiNH₂ in a substantially inert atmosphere in amounts sufficient to obtain a hydrogen adsorption of at least about 3 wt %. Additionally, the lithium-magnesium compound can have a hydrogenated lithium-magnesium product in a hydrogen adsorbed state such that the hydrogen adsorbed and desorbed states are reversible.

Even though the present invention can be discussed in terms of distinct systems, methods, and compositions, the following discussions are applicable to each embodiment as provided herein. In other words, when discussing a lithium-magnesium compound in a hydrogen storage material, such a discussion is equally applicable to a method of making such a material or a system using such a material, and vice versa.

Surprisingly, it has been discovered that LiMgN can be formed by the reaction between LiNH₂ and MgH₂ when the molar ratio of LiNH₂ to MgH₂ is about 1:1 as shown below by the reaction described in Formula 1. As such, in one embodiment, a reversible hydrogen storage material can be formed from MgH₂ and LiNH₂ in substantially equal molar amounts, although 0.9:1.1 to 1.1:0.9 can also be acceptable. Ratios outside this range can also be usable, although the reversible hydrogen content will decrease in that excess amounts would simply contribute excess weight with less contribution to the reversible amount of hydrogen.

Additionally, the MgH₂ and LiNH₂ can be heated in a gaseous state. The reaction in Formula 1 and its reversibility were studied experimentally.

MgH₂+LiNH₂→LiMgN+2H₂ Formula 1

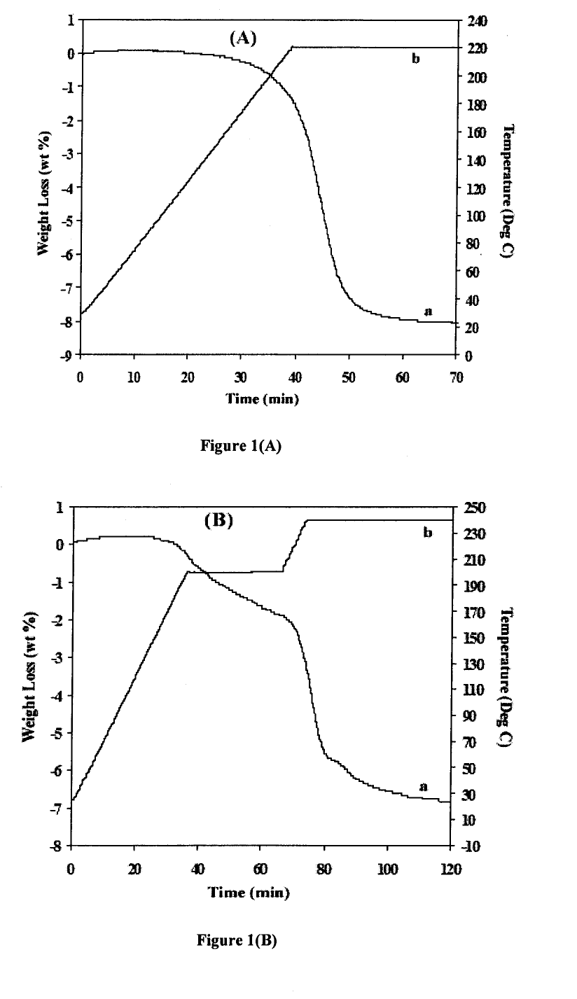

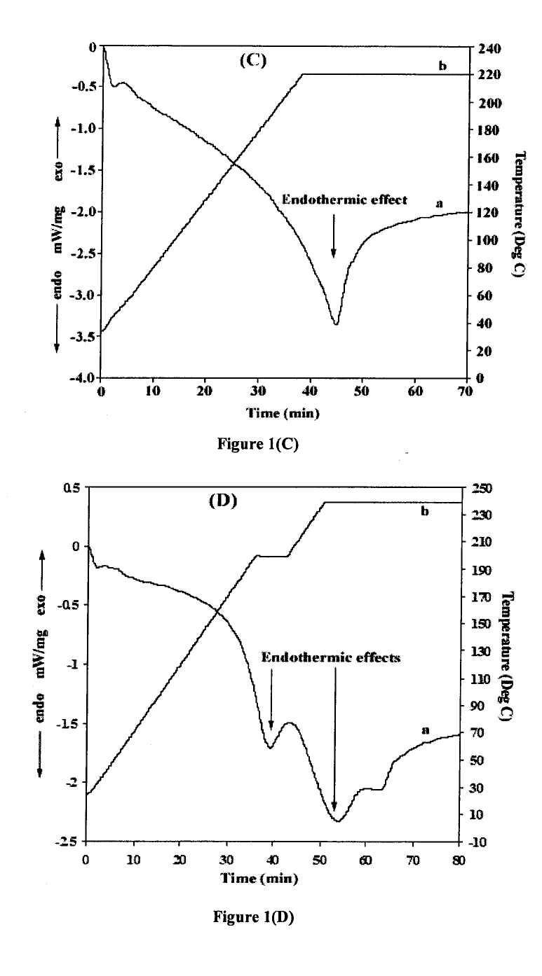

FIG. 1(A) shows that 8.1 wt % of hydrogen can be released below 200° C. by Formula (1). After rehydrogenation of the LiMgN, FIG. 3 shows that LiMgN can provide a release of hydrogen of greater than 6% by weight.

Such LiMgN formation is not provided by simply choosing appropriate starting materials. For example, the dehydrogenation characteristics of a mixture of LiNH₂ and MgH₂ with a molar ratio of 2:1 show a completely different composition as compared to the present composition. When LiNH₂ and MgH₂ are reacted in 2:1 ratio, nearly 90% (˜4.7 wt %) of the total predicted hydrogen was released at the temperature of 220° C., and the dehydrogenated product was ternary imide, Li₂Mg(NH)₂. As such, variations in the molar ratio can produce different products. While the initial conversion of LiNH₂ and MgH₂ seems to involve Mg(NH₂)₂ and LiH as intermediates as well as Li₂Mg(NH)₂, it is thought that the molar ratios of the intermediate reactions are different. The following can represent the final hydrogen storage compositions from the intermediate reaction products for both systems:

$$\frac{1}{2} {Mg ( {NH}_{2} )}_{2} + \frac{1}{2} {MgH}_{2} + Li H \to LiMgN + 2 {H}_{2} \qquad Formula 2$$

Mg(NH₂)₂+2LiH→Li₂Mg(NH)₂+4H₂ Formula 3

Compared to the Li₂Mg(NH)₂ system as shown in Formula 3, the current invention can have different intermediate species as well as different molar ratios, as shown in Formula 2, leading to a hydrogen storage material that can have a much higher hydrogen capacity at even lower temperature range, as shown in FIG. 1(A). While not intending to be bound by any one theory, the differences in the compositions after dehydrogenation are most likely due to a different dehydrogenation mechanism caused by the differences in the molar ratio of the starting materials, LiNH₂ and MgH₂, and other possible intermediates, as seen in Formulas 2 and 3.

As described above, the dehydrogenation behavior of the mixture of LiNH₂/MgH₂ has been changed due to different molar ratios and possibly from different milling methods employed. As such, in one embodiment, a method of making LiMgN can include using a high energy high pressure (HEHP) milling. However, the dehydrogenation process appears to experience two steps indicated by the DTA results, as shown in FIG. 1(D). Based on the current understanding regarding the reactions between Mg(NH₂)₂ and LiH as well as Mg(NH₂)₂ and MgH₂, these two-step hydrogen desorption processes in the current system can be described by the either Formula 4 or Formula 5:

$$\begin{matrix}\frac{1}{2} {Mg ( {NH}_{2} )}_{2} + LiH \to \frac{1}{2} {Li}_{2} {MgN}_{2} {H}_{2} + {H}_{2} \\ \frac{1}{2} {Li}_{2} {MgN}_{2} {H}_{2} + \frac{1}{2} {MgH}_{2} \to LiMgN + {H}_{2} & Formula 4 \\ \frac{1}{2} {Mg ( {NH}_{2} )}_{2} + \frac{1}{ 2} {MgH}_{2} \to MgNH + {H}_{2} \\ MgNH + LiH \to LiMgN + {H}_{2} & Formula 5\end{matrix}$$

Although the exact mechanism is yet to be fully understood, the methods and compositions of the present invention provide a reversible hydrogen storage material comprising LiMgN in a hydrogen desorbed state.

Generally, the LiMgN can adsorb and/or the hydrogenated lithium-magnesium product can desorb hydrogen at a temperature of from about −10° to about 400° C. In one embodiment, the LiMgN can adsorb and/or the hydrogenated lithium-magnesium product can desorb hydrogen at a temperature of from about 0° to about 300° C. In another embodiment, the LiMgN can adsorb and/or the hydrogenated lithium-magnesium product can desorb hydrogen at a temperature of from about 20° to about 250° C., and in some cases from about 160° C. to 220° C.

Additionally, the LiMgN can adsorb hydrogen under a pressure of from about 1 to about 250 atm. In one embodiment, the LiMgN can adsorb hydrogen under a pressure of from about 1 to about 175 atm. In another embodiment, the LiMgN can adsorb hydrogen under a pressure of from about 1 to about 150 atm. For example, in one embodiment rehydrogenation under 136 atm hydrogen gas at 160° C. and TiCl₃ doping results in about 8.0 wt % hydrogen storage.

After the LiMgN adsorbs hydrogen, the LiMgN can form a hydrogenated lithium-magnesium product. As such, the magnesium-lithium hydride/amide compounds can desorb hydrogen at a pressure of from about 0.1 to about 150 atm. In one embodiment, the magnesium-lithium hydride/amide compounds can desorb hydrogen at a pressure of from about 0.1 to about 75 atm. In another embodiment, the magnesium-lithium hydride compound can desorb hydrogen at a pressure of from about 0.1 to about 50 atm.

As previously discussed, the present methods, systems, and compositions can have a lithium-magnesium compound having LiMgN in a hydrogen desorbed state and can be formed by reacting MgH₂ and LiNH₂ in a substantially inert atmosphere in amounts sufficient to obtain a hydrogen adsorption of at least about 3 wt %. As such, the lithium-magnesium compound can be formed at a temperature of from about 100° to about 300° C. In one embodiment, the lithium-magnesium compound can be formed at a temperature of from about 140° to about 200° C.

The lithium-magnesium compound can be formed such that it can obtain a hydrogen adsorption of at least about 5 wt %. In one embodiment, the hydrogen adsorption can be at least about 6 wt %. In another embodiment, the hydrogen adsorption can be at least about 7 wt %. In yet another embodiment, the hydrogen adsorption can be at least about 8 wt %. As such, the lithium magnesium compound can have LiMgN adsorbing from about 3% to about 8% hydrogen by weight. In one embodiment, the lithium magnesium compound can have LiMgN adsorbing from about 5% to about 8% hydrogen by weight. In another embodiment, the lithium magnesium compound can have LiMgN adsorbing from about 6% to about 8% hydrogen by weight. In yet another embodiment, the lithium magnesium compound can have LiMgN adsorbing from about 7% to about 8% hydrogen by weight.

The compositions, methods, and systems of the present invention can provide an overall hydrogen efficiency of greater than 50%. In one embodiment, the hydrogen efficiency can be from about 60% to about 100%. In another embodiment, the hydrogen efficiency can be from about 70% to about 100%. In yet another embodiment, the hydrogen efficiency can be from about 80% to about 100%.

While the present invention has been achieved through various milling procedures as is common in the art, other reaction schemes may be employed to produce the reversible hydrogen storage material. For example, the starting materials can be vaporized to a gaseous state and subsequently reacted forming the reversible hydrogen storage material as described herein.

In addition to the embodiments described herein, the hydrogen storage material can further comprise a hydrogen storage catalyst selected from the group consisting of TiCl₃, TiF₃, metallic Ti, TiCl₄, TiCl₂, Ti, Ti(OBuⁿ)₄, AlCl₃F₄, TiBr₂, TiBr₃, TiBr₄, TiI₂, TiI₃, TiI₄, and mixtures thereof. Furthermore, other catalysts such as, but not limited to, zirconium, palladium, platinum, compounds and alloys thereof, and the like may also be suitable for use in the present invention. In one embodiment, the hydrogen storage catalyst can be TiCl₃ or TiCl₃-1/3AlCl₃. The hydrogen storage catalyst can be present in the reversible hydrogen storage material from about 0.1% to about 6% by weight. In one embodiment, the hydrogen storage catalyst can be present in the reversible hydrogen storage material from about 1% to about 5% by weight. In another embodiment, the hydrogen storage catalyst can be present in the reversible hydrogen storage material from about 2% to about 5% by weight, although catalyst content from 0.1% to 20% may also be suitable in some cases.

The hydrogen storage material having a hydrogen storage catalyst can be hydrogenated at about 0° C. to about 300° C. In one embodiment, the hydrogen storage material having a hydrogen storage catalyst can be hydrogenated at about 0° C. to about 250° C. In another embodiment, the hydrogen storage material having a hydrogen storage catalyst can be hydrogenated at about 0° C. to about 200° C. In yet another embodiment, the hydrogen storage material having a hydrogen storage catalyst can be hydrogenated at about 0° C. to about 160° C.

### EXAMPLES

### Example 1

### Preparation of LiMgN

The starting materials, lithium amide (LiNH₂, 95%), magnesium hydride (MgH₂), were purchased from Aldrich Chemical and used as received without any further purification. To prevent samples and raw materials from undergoing oxidation and/or hydroxide formation, they were stored and handled in an argon-filled glove box. Reactant mixtures were prepared using mechanical milling. Approximately 2.0 g mixtures were milled with a Spex 8000 mill or jar-roll mill under argon atmosphere with the ball to powder ratio of 35:1 by weight. The milling time was varied from 12 to 24 hours.

The thermal gas desorption properties of the mixture (MgH₂/LiNH₂) were determined by thermogravimetry analyzer (TGA, Shimadzu TGA50) and differential thermal analyzer (DTA Shimadzu DTA50) upon heating to 220-250° C. at a heating rate of 5° C./min. This equipment was especially designed and built for using it inside the argon-filled glove box equipped with a regeneration system, which permitted simultaneously performing TGA and DTA without exposure of the sample to air.

A mixture of MgH₂ and LiNH₂ with a molar ratio of 1:1 was prepared by ball milling for 24 hours. The ball milling was intentionally carried out using the so-called jar-rolling method, which is a low speed and low energy milling method. By using the jar-rolling method, side reactions were avoided during milling and the original phases were preserved, while still ensuring uniform mixing of the reactants powder.

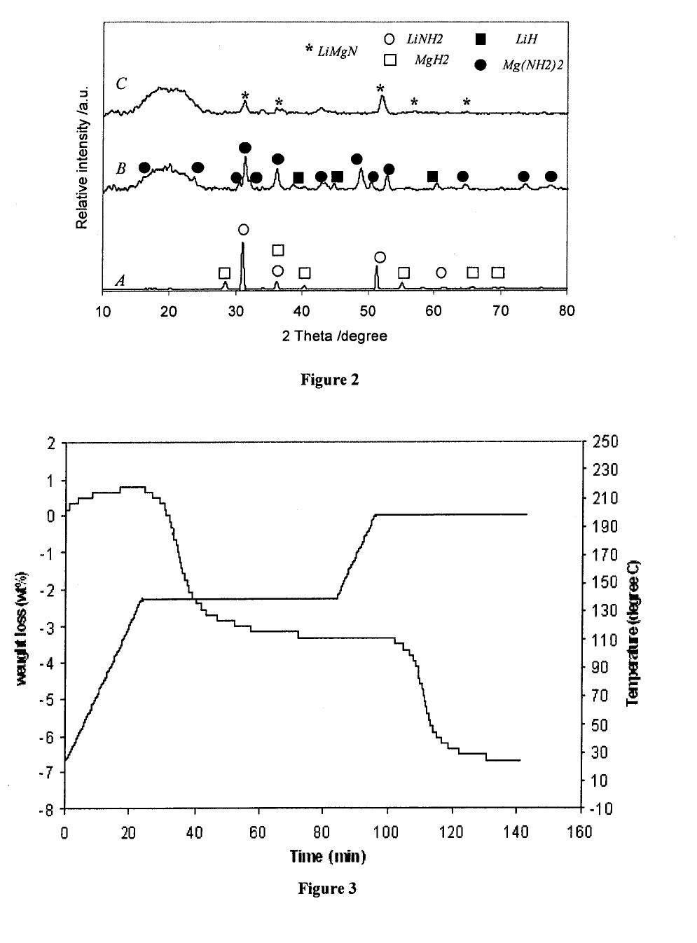

FIG. 2 shows the XRD pattern of the powder before and after jar-rolling. In FIG. 2A, the peaks marked with open squares are attributed to the phase of MgH₂, and those marked with open circles are attributed to the phase of tetragonal LiNH₂. This indicates that there were no phase changes or reactions during the jar-roll ball milling. In other words, both LiNH₂ and MgH₂ were preserved during milling. The milling specimens were then analyzed using TGA to study the dehydrogenation reaction. The identification of reactants and reaction products in the mixture before and after thermogravimetric analysis was carried out using a Siemens D5000 model X-ray diffractometer with Ni-filtered Cu Kα radiation (λ=1.5406 Å). A scanning rate of 0.02°/s was applied to record the patterns in the 2θ range of 10° to 90°. In addition, it is noted that the amorphous-like background in the XRD patterns is attributed to the thin plastic films that were used to cover the powders.

FIG. 1A shows the TGA profile of the MgH₂/LiNH₂ mixture after jar-roll ball milling. FIG. 1A shows that the reaction started at the temperature of about 120° C. and the weight-loss accelerated at the temperature of 200° C. A total of 8.1 wt % of hydrogen was released after the sample was held at the temperature of 220° C. for 20 minutes. Assuming all the weight loss is due to the release of hydrogen, the dehydrogenation process can be considered complete because the theoretical capacity is 8.2%, as indicated by Formula 1.

MgH₂+LiNH₂→LiMgN+2H₂ Formula 1

It should be noted that one of the concerns for using TGA to analyze amide containing material systems is the possibility of the co-production of ammonia gas during the dehydrogenation process. We believe that NH₃ co-production was minimal in this reaction for the following reasons. First, the weight loss percentages recorded by TGA matches the stoichiometric values of Formula 1 for hydrogen release. Therefore, the effect of the weight loss due to NH₃, if any, is negligible. Second, because the reaction between NH₃ and metal hydrides, such as LiH and MgH₂, are very fast, any NH₃ gas generated is likely to be captured by metal hydrides present in the system. Third, based on experience and other amide systems the amount of NH₃ produced during the reaction of amides with metal hydrides is generally minimal (in ppm level) as detected by IGA or ion/PH meter.

In order to further verify this specific reaction step, differential thermal analysis (DTA) and X-ray diffraction (XRD) analysis was carried out. FIG. 1C shows the DTA profile of the mixture after jar-roll ball milling. It can be seen that there is one endothermic peak in the DTA curve, which corroborates the TGA result that the hydrogenation was completed in a one-step reaction. Integration of the endothermic peak gave the value of heat of reaction of 33.5 kJ/mol H₂, which is very close to the theoretical predicted reaction enthalpy of 29.7 (31.9) kJ/mol H₂ using the USPP (PAW) approach. FIG. 2 compares the XRD patterns of the samples before and after dehydrogenation. Crystalline phases were identified by comparing the experimental data with JCPDS files from the International Center for Diffraction Data. FIG. 2, line C shows the XRD pattern of the sample after dehydrogenation, in which all the peaks except for those marked with asterisk can be indexed to be the cubic phase of LiMgN, which further supports that the dehydrogenation reaction followed the reaction indicated by Formula 1. The peaks marked with asterisk can be indexed to the phase of Li₂O, which most likely formed during sample preparation when it was exposed to air.

### Example 2

### Preparation of Lithium-Magnesium Hydride/Amide/Imide Compounds

The hydrogen absorption properties of the LiMgN from Example 1 were performed by using a custom-made autoclave, whose hydrogen pressure limit is up to 5000 psi, and temperature is programmed up to 500° C. Specifically, rehydrogenation was conducted by heating 500 mg of the LiMgN to 240-300° C. at a heating rate of 5° C./min under argon atmosphere, and then holding at 240-300° C. for 1-7 hour under 2000 psi of pressurized hydrogen.

The hydrogenation of LiMgN and the reversibility of reaction described by Formula 1 was investigated by placing the LiMgN in a custom-made autoclave and pressurized in H₂. The hydrogenation experiment was carried out at 2000 psi and 240° C.

The hydrogenated product was analyzed using TGA. FIG. 3 shows TGA profile of the hydrogenated sample. FIG. 3 shows that the sample adsorbed about 7.2 wt % of hydrogen during the experiment. However, from the TGA results, the dehydrogenation behavior of the hydrogenated LiMgN sample appears to be a two-step process rather than a one-step process.

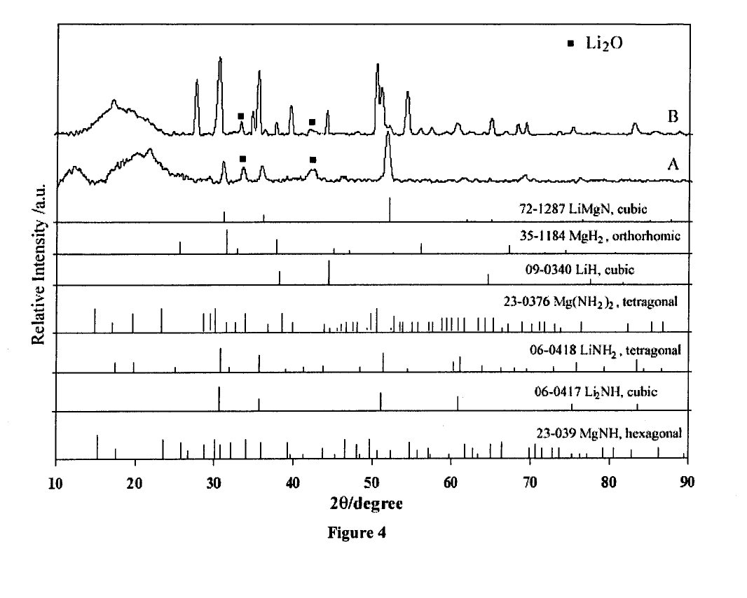

In order to understand the hydrogenation and dehydrogenation reactions, X-ray diffraction analysis was carried out on the LiMgN before and after hydrogenation and TGA after hyrogenation. In FIG. 4A, which shows the XRD pattern of LiMgN before hydrogenation, the peaks marked with asterisk are attributed to the phase of LiMgN. FIG. 4B shows the XRD pattern of LiMgN after hydrogenation. It clearly shows that LiMgN was absent in the sample, indicating that it was consumed by the reaction with hydrogen and new compounds formed.

To identify possible phases contained in the rehydrogenated sample, the XRD patterns for selected pure materials, which may be parts of the rehydrogenation products, are shown in FIG. 4 as vertical bars at the bottom for comparison. Compared with these standards, the XRD pattern of the sample after hydrogenation of LiMgN appears to contain Mg(NH₂)₂, LiH, MgH₂. While not intending to be bound by any particular theory, the hydrogenation reaction of LiMgN can be described by Formula 2, which is simply a restatement of Formula 1:

$$LiMgN + 2 {H}_{2} \to \frac{1}{2} {Mg ( {NH}_{2} )}_{2} + \frac{1}{2} {MgH}_{2} + LiH \qquad Formula 2$$

Formula 2 shows a different reversible reaction pathway involving LiMgN and H₂ from that of Formula 1.

### Example 3

### Preparation of Hydrogenated Lithium Magnesium Products

Another mixture MgH₂/LiNH₂ was prepared using a high-energy ball milling method—planetary milling. After high energy milling, the sample was again subjected to analysis using TGA. FIG. 1B shows TGA profile of this mixture after high-energy-high-pressure (HEHP) planetary milling under 70 bar of hydrogen for 2 hours. The weight loss of this sample was approximately 7 wt %, which is significantly lower than that of the sample after jar-roll milling. Moreover, from the TGA profile shown in FIG. 1B, the dehydrogenation process appears to be a two-step process rather than the one-step process from the sample after jar-roll milling. The first step occurred between the temperature range of 140-200° C., and the second step between the temperature range of 200-240° C. This dehydrogenation behavior is similar to the hydrogenated LiMgN.

DTA and XRD analyses were carried out to further verify these specific reaction steps during HEHP milling and during dehydrogenation. DTA profiles of the mixture after HEHP milling showed two endothermic peaks (FIG. 1D), which corroborate with the TGA result that the dehydrogenation process (TGA curve, FIG. 1B) was completed in two steps.

FIG. 2B shows the XRD pattern of the mixture after HEHP milling. FIG. 2B shows that the LiNH₂ was absent in the sample. Instead, several peaks match that of MgH₂, LiH, and possibly Mg(NH₂)₂. This supports that chemical reactions took place between MgH₂ and LiNH₂ during HEHP milling. While not intending to be bound by any particular theory, this reaction is proposed as follows

$${MgH}_{2} + {LiNH}_{2} \to \frac{1}{2} {Mg ( {NH}_{2} )}_{2} + \frac{1}{2} {MgH}_{2} + LiH \qquad Formula 3$$

The XRD pattern of the dehydrogenated products of the sample after HEHP milling (FIG. 2C) shows that the product LiMgN, which is the same as the sample after jar-roll milling. The above information supports that the ternary nitride LiMgN can be obtained via different pathways from that of Formula 1. However, it is noted that the reversible hydrogenation and dehydrogenation reactions involving LiMgN and H₂ may also have different reaction mechanisms that are not yet clearly understood.

### Example 4

### Preparation of TiCl₃-Doped LiMgN

The starting materials, LiNH₂, MgH₂ and TiCl₃ were purchased from Aldrich Chemical and used as received without any further purification. They were stored and handled in an argon-filled glove box to prevent samples and raw materials from undergoing oxidation and/or hydroxide formation. Reactant mixtures were prepared using mechanical milling. Approximately 2.0 g mixtures were milled in a rolling jar ball mill argon atmosphere with a ball to powder ratio of 35:1 by weight. The milling time was varied from 12 to 24 hours.

The thermal gas release properties of the mixture (MgH₂/LiNH₂) were determined by a thermogravimetric analyzer (TGA, Shimadzu TGA50) and a differential thermal analyzer (DTA, Shimadzu DTA50) by heating to 220-250° C. at a heating rate of 5° C./min. This equipment was specially designed and built to be used inside the argon-filled glove box equipped with a gas purification system, which permitted simultaneously performing TGA and DTA without exposure of the sample to air. The hydrogenation of the TiCl₃-doped LiMgN was conducted by using a custom-made autoclave with a hydrogen pressure limit up to 5000 psi and temperature up to 500° C., followed by TGA analysis. Specifically, rehydrogenation was conducted by heating 500 mg of the mixture (MgH₂/LiNH₂/4 wt % TiCl₃) to 220-250° C. at a heating rate of 5° C./min under argon atmosphere, and then holding at 160-300° C. for 1-7 hours under 2000-3000 psi of hydrogen pressure.

The identification of reactants and reaction products in the mixture before and after the thermogravimetric analysis was carried out using a Siemens D5000 model X-ray diffractometer with Ni-filtered Cu Kα radiation (λ=1.5406 Å). A scanning rate of 0.02°/s was applied to record the patterns in the 2θ range of 10° to 90°.

FTIR spectra were collected using a Bruker Tensor-37 spectrometer via transmission of the IR through a pressed potassium bromide (KBr) pellet. Each spectrum is created from 64 scans averaged together with a resolution of 4 cm⁻¹. The samples were prepared in an argon-filled glove box by grinding a small amount of the sample with fully dried KBr powder in an agate mortar and pestle. The ground sample was then transferred to a custom holder and pressed into a pellet of approximately 7 mm in diameter and 1-2 mm thick. The sample holder was then removed from the glove box and transferred to the spectrometer immediately. The samples were placed one at a time into the sample compartment of the spectrometer. After mounting a sample in place the sample compartment was purged by nitrogen for approximately 10 min prior to collection of the spectrum.

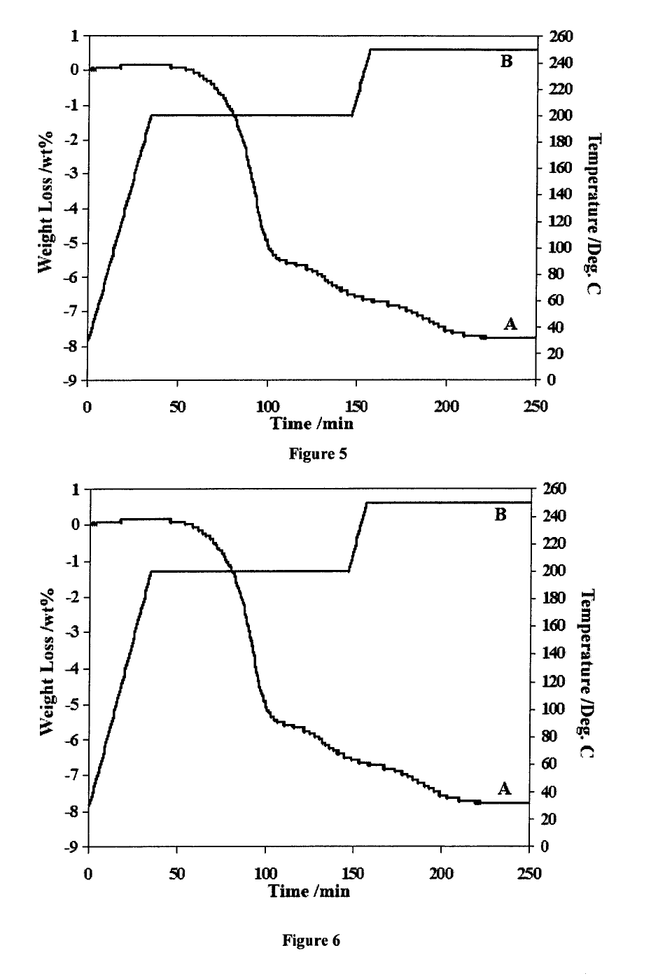

FIG. 5 shows the TGA curve of the hydrogenated TiCl₃-doped (4 wt %) LiMgN, which was hydrogenated at 2000 psi and 160° C. for 6 hours. FIG. 5 shows that the TiCl₃-doped LiMgN gained about 8.0 wt % hydrogen from the rehydrogenation process. The TGA curve also shows that the dehydrogenation of the hydrogenated TiCl₃-doped LiMgN occurred at nearly identical temperature ranges as that of the hydrogenated LiMgN without catalyst as shown in FIG. 3. Compared to the hydrogenation temperature of LiMgN without doping, it is also noted that, LiMgN with TiCl₃ doping can be hydrogenated at much lower temperatures (160° C.) than the material without TiCl₃ doping, which is another evidence that TiCl₃ significantly improves the kinetic rate of the hydrogenation reaction of LiMgN.

The present material was also shown to be reversible by short-cycle experiments of the hydrogenation and dehydrogenation reactions carried out using the autoclave system as described earlier. Selected specimens of TiCl₃-doped LiMgN were placed in the reaction vessel and subjected to hydrogenation under 2000 psi of H₂ pressure at 160° C. for 7 hours and dehydrogenation by cooling after hydrogenation and heating to 240° C. with 5° C./min under argon atmosphere. Five cycles of hydrogenation and dehydrogenation procedures were carried out. The specimens after the short-cycle experiments (in hydrogenated state) were then analyzed using TGA. The results are shown in FIG. 6, which shows about 7.9 wt % of reversible hydrogen storage capacity; further demonstrating that the hydrogenation/dehydrogenation of LiMgN is reversible with TiCl₃ as catalyst.

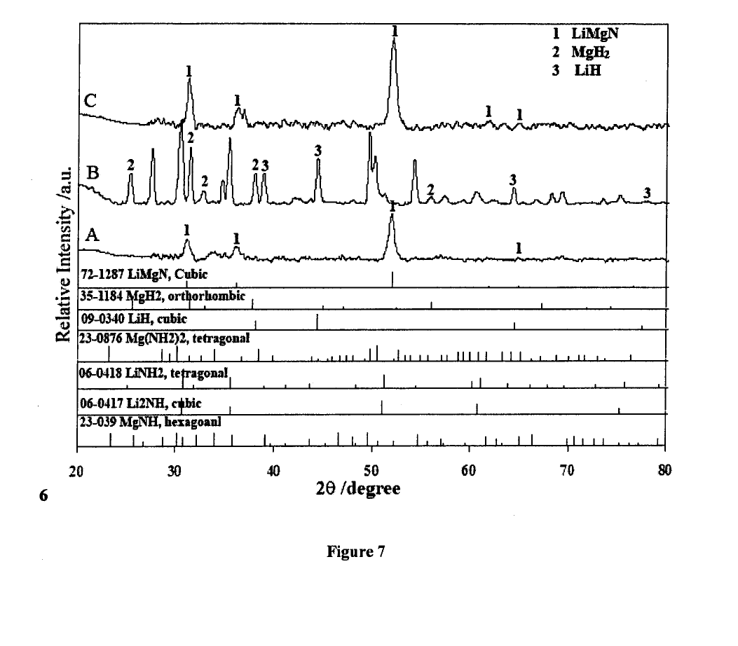

Additionally, X-ray diffraction analysis was carried out on TiCl₃-doped LiMgN before and after hydrogenation. In FIG. 7A, which shows the XRD patterns of TiCl₃-doped LiMgN before hydrogenation, the peaks marked with “1” are attributed to the phase of LiMgN. FIG. 7B shows the XRD patterns of TiCl₃-doped LiMgN after hydrogenation. As described in compositions without the catalyst, LiMgN is absent in the hydrogenated sample, supporting that it is consumed by the reaction with hydrogen and new compounds were formed. Further, the XRD pattern (FIG. 7B) shows there is no LiNH₂ phase that can be identified in the hydrogenated product, which suggests that the hydrogenation reaction did not follow that of the reverse reaction of Formula 1:

MgH₂+LiNH₂→LiMgN+2H₂ Formula 1

The reversible hydrogenation and dehydrogenation reactions using LiMgN, therefore, experienced a different reaction pathway. To identify possible phases contained in the rehydrogenated sample, the XRD patterns for selected pure materials, which may be parts of the rehydrogenation products, are shown in FIG. 7 (and FIG. 4) as vertical bars at the bottom for comparison. Compared with these standards XRD patterns, the hydrogenated product of TiCl₃-doped LiMgN contains LiH, MgH₂, and possible Mg(NH₂)₂.

However, conclusive identification of the hydrogenated sample solely by using XRD technique is still very difficult because the overlap of XRD patterns of several phases such as Mg(NH₂)₂ and LiNH₂, which are all possible substances in the system. Further, there are also possibilities that there may also be other complex compounds of Li. Mg, N, and H, such as Li₂Mg(NH)₂, of which the XRD pattern is not available in the database. Li₂Mg(NH)₂, is also a possible product component, although the comparison of known XRD for this compound showed that neither the dehydrogenated nor the hydrogenated products contains Li₂Mg(NH)₂ phase. FIG. 7, line C shows the XRD patterns of the dehydrogenated products of the hydrogenated TiCl₃-doped LiMgN, in which only LiMgN phase can be detected. This again supports that the hydrogenation/dehydrogenation of TiCl₃-doped LiMgN is reversible (in FIGS. 7A-C, the amorphous-like broad peak around 20°/2θ is from the thin plastic films that were used to cover the powders).

Since it is difficult to accurately characterize the hydrogenating reactions relying solely on XRD patterns, FT-IR technique was employed for further analysis. FT-IR is an effective technique for identifying different N—H bonds resulting from conversions between amides, imides and nitrides. Therefore, by analyzing the reactants and products using it can provide direct evidence for the hydrogenation and dehydrogenation mechanism of LiMgN. Table I lists FT-IR peak assignments for LiNH₂, Li₂NH, Mg(NH₂)₂, MgNH and Li₂Mg(NH)₂ which were used for identification such species in the sample.

TABLE 1
FTIR peak assignments for amides and imides of Li and Mg

| Samples | Position (cm⁻¹) | assignment^{a} |
|---|---|---|
| Mg(NH₂)₂ | 3325 | νₐₛ |
| LiNH₂ | 3313 | νₐₛ |
| Mg(NH₂)₂ | 3274 | νₛ |
| LiNH₂ | 3259 | νₛ |
| MgNH | 3251 | ν |
| MgNH | 3240 | ν |
| MgNH | 3197 | ν |
| Li₂NH | 3162 | ν |
| Li₂Mg(NH)₂²¹ | 3150-3200 | ν |
| Mg(NH₂)₂ | 1572 | δ |
| LiNH₂ | 1568.2 | δ |
| LiNH₂ | 1563 | δ |
| MgNH | 1560 | δ |
| LiNH₂ | 1559.6 | δ |
| LiNH₂ | 1539.3 | δ |

^{a}νₐₛ: asymmetric stretch; νₛ: symmetric stretch; ν: stretch; δ: bend

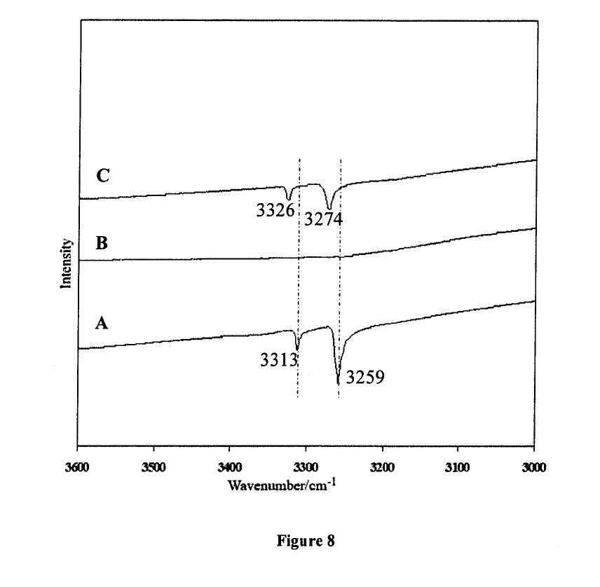

From this table, it can be seen that the effects of Mg or Li on the stretching and bending vibration frequencies of the —NH₂ and —NH bond are significant. These values will be used as a guideline to distinguish Mg(NH₂)₂ and LiNH₂, or MgNH and Li₂NH. FIG. 8 shows the FTIR absorption spectra for three samples, i.e. as-ball milled, after dehydrogenation and after rehydrogenation of the dehydrogenated product. The as-ball milled sample consists of LiNH₂ because of the appearance of the peaks at 3313 and 3259 cm⁻¹, as shown in FIG. 8, line A. Corroborating the XRD results, FIG. 8 confirms that the reactant phases are preserved after ball milling. After dehydrogenation, the sample does not show any peaks in the area of 3100-3400 cm⁻¹ in the IR spectrum (FIG. 8B), which indicates that there is no N—H bond in the dehydrogenated product, therefore, considering also the XRD results, the dehydrogenated product was LiMgN. FIG. 8C shows the IR spectrum of the rehydrogenated sample, in which the peaks at 3326 and 3274 cm⁻¹ belong to Mg(NH₂)₂ phase. In other words, the rehydrogenated product consists of Mg(NH₂)₂ rather than LiNH₂ or Li₂Mg(NH)₂, which is also in agreement with the XRD results shown in FIG. 8B.

Without being bound to any particular theory, the hydrogenation reaction of LiMgN appears to be as follows:

$$LiMgN + 2 {H}_{2} \to \frac{1}{2} {Mg ( {NH}_{2} )}_{2} + \frac{1}{2} {MgH}_{2} + LiH \qquad ( 4 )$$

with a theoretical hydrogen capacity based on this reaction also being 8.2 wt %.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A reversible hydrogen storage system comprising:
(a) a hydrogen storage material that includes a lithium-magnesium compound, said lithium-magnesium compound having a LiMgN in a hydrogen desorbed state and a lithium-magnesium hydride compound in a hydrogenated state, wherein said hydrogenated and desorbed states are reversible; and
(b) a vessel containing the hydrogen storage material.

2. The reversible hydrogen storage system of claim 1, wherein the hydrogen storage material further comprises a hydrogen storage catalyst selected from the group consisting of TiCl₃, TiF₃, metallic Ti, TiCl₄, TiCl₂, Ti, Ti(OBuⁿ)₄F₄, TiBr₂, TiBr₃, TiBr₄, TiI₂, TiI₃, TiI₄, and mixtures thereof.

3. The reversible hydrogen storage system of claim 1, wherein the LiMgN absorbs and/or the magnesium lithium hydride compound desorbs hydrogen at a temperature of from about −10° to about 400° C.

4. The reversible hydrogen storage system of claim 1, wherein the LiMgN adsorbs hydrogen under a pressure of from about 1 to about 200 atm.

5. The reversible hydrogen storage system of claim 1, wherein the magnesium-lithium hydride compound desorbs hydrogen at a pressure of from about 0.1 to about 100 atm.

6. The reversible hydrogen storage system of claim 1, wherein the LiMgN adsorbs from about 3% to about 8% hydrogen by weight.

7. The reversible hydrogen storage system of claim 6, wherein the LiMgN adsorbs from about 5% to about 8% hydrogen by weight.

8. A method of reversibly storing hydrogen comprising the steps of:
(a) reacting hydrogen with a LiMgN to form a magnesium-lithium hydride compound; and
(b) desorbing hydrogen from the magnesium-lithium hydride compound to form the LiMgN.

9. The method of reversibly storing hydrogen of claim 8, wherein the step of adsorbing and/or desorbing hydrogen occurs at a temperature of from about −10° to about 400° C.

10. The method of reversibly storing hydrogen of claim 8, wherein the step of adsorbing hydrogen occurs at a pressure of from about 1 to about 200 atm.

11. The method of reversibly storing hydrogen of claim 8, wherein the step of desorbing hydrogen occurs at a pressure of from about 0.1 to about 100 atm.

12. The method of reversibly storing hydrogen of claim 8, wherein the step of adsorption accounts for a change in weight of the LiMgN of from about 3% to about 8%.

13. The method of reversibly storing hydrogen of claim 12, wherein the change in weight of the LiMgN is of from about 5% to about 8%.

14. A hydrogen storage material formed by the process of claim 8.

15. A reversible hydrogen storage material comprising a lithium-magnesium compound, said lithium-magnesium compound having a LiMgN in a hydrogen desorbed state and is formed by reacting MgH₂ and LiNH₂ in a substantially inert atmosphere in amounts sufficient to obtain a hydrogen adsorption of at least about 3%, and a hydrogenated lithium magnesium product in a hydrogen adsorbed state, wherein said hydrogen adsorbed and desorbed states are reversible.

16. The reversible hydrogen storage material of claim 15, further comprising a hydrogen storage catalyst selected from the group consisting of TiCl₃, TiF₃, metallic Ti, Ti(OBuⁿ)₄, TiCl₄, TiCl₂, Ti, TiF₄, TiBr₂, TiBr₃, TiBr₄, TiI₂, TiI₃, TiI₄, and mixtures thereof.

17. The reversible hydrogen storage material of claim 16, wherein the hydrogen storage catalyst is present in the reversible hydrogen storage material from about 0.1% to about 20% by weight.

18. The reversible hydrogen storage material of claim 15, wherein the lithium-magnesium compound is formed at a temperature of from about 100° to about 300° C.

19. The reversible hydrogen storage material of claim 18, wherein the lithium-magnesium compound is formed at a temperature of from about 140° to about 200° C.

20. The reversible hydrogen storage material of claim 15, wherein the MgH₂ and LiNH₂ are in substantially equal molar amounts.

21. The reversible hydrogen storage material of claim 16, wherein the LiMgN adsorbs from about 5% to about 8% hydrogen by weight.

22. A method of making a reversible hydrogen storage material comprising the step of:
a) heating MgH₂ and LiNH₂ in a substantially inert atmosphere forming a lithium-magnesium compound that has a hydrogenation capacity of at least about 3%;
wherein the lithium-magnesium compound desorbs hydrogen to form a LiMgN and adsorbs hydrogen to form a hydrogenated lithium magnesium product.

23. The method of making a reversible hydrogen storage material of claim 22, wherein the step of heating further comprises a hydrogen storage catalyst selected from the group consisting of TiCl₃, TiF₃, metallic Ti, TiCl₄, TiCl₂, Ti, Ti(OBuⁿ)₄F₄, TiBr₂, TiBr₃, TiBr₄, TiI₂, TiI₃, TiI₄, and mixtures thereof.

24. The method of making a reversible hydrogen storage material of claim 22, wherein the adsorption of hydrogen accounts for a change in weight of the LiMgN of from about 3% to about 8%.

25. The method of making a reversible hydrogen storage material of claim 22, wherein the MgH₂ and LiNH₂ are heated in a gaseous state.
